(19) United States
(12) Patent Application Publication
(10) Pub. No.: US 2008/0299259 A1
(43) Pub. Date: Dec. 4, 2008

(54) Food Product Provided with Individually Apparent Added Ingredients

(75) Inventor: Jean Neve De Mevergnies, Marville (FR)

Correspondence Address: BIRCH STEWART KOLASCH & BIRCH, PO BOX 747, FALLS CHURCH, VA, 22040-0747, US

(73) Assignee: Mosaico SPRL, Bastogne (BE)

(21) Appl. No.: 11/814,359

(22) PCT Filed: Jan. 23, 2006
(86) PCT No.: PCT/BE2006/000004

§ 371 Date: Jul. 28, 2008

(30) Foreign Application Priority Data
Jan. 21, 2005 (BE) 2005/0040

(51) Int. Cl. A21D 13/08; A21D 15/08; A23L 1/30; A23L 1/302; A23L 1/36; B65B 25/06; A23L 1/304; A23L 1/305; A23L 1/31

(52) U.S. Cl. 426/72; 426/89; 426/103; 426/93; 426/92; 426/443; 426/556; 426/392

(57) ABSTRACT

The inventive food product comprises a support consisting of a comestible material and comestible individually apparent added ingredients and is characterised in that a fixing product is applied in the form of a film to at least one surface of said product in such a way that it makes it possible to fix the added ingredients, thereby ensuring the adhesion of the assembly, said fixing product is transparent and comestible and the support is at least partially visible.

The present invention relates to a food product comprising a support and edible added ingredients which are individually apparent.

Cereal products are known which contain added ingredients in the form of pieces bound by means of chocolate materials or materials with a sweetened base which either coat, cover or encrust the said added ingredients. However, with these known products, the added ingredients are at least partially masked. In addition, products with such a composition have a sweet or chocolate taste, which is not always desired. Furthermore, the addition of sweetened or chocolate material increases the calorie supply of the combination, which it is often sought to avoid as far as possible.

Moreover, a combination of this type is sticky or melting to the touch, which is unpleasant.

Biscuits are also known which comprise added ingredients at their surface, such as cheese, sauce, tomato, fat comprising pieces of fine herbs and/or of spices. In this case, the cohesion of the combination is provided by its baking, which softens the fats. Next, the combination is cooled, which solidifies and congeals the fats, and makes it possible to bind the added ingredients.

Biscuits or bread rolls comprising added ingredients at the surface, such as sesame, poppy and the like, weakly maintained at the surface, are also known. However, in this case, maintaining the combination is uncertain. It is achieved by the starch of the base layer which is solidified during the baking of the whole. In this case, the added ingredients are deposited on a soft or pasty support, which partially embeds them into the support.

The present invention aims to provide a food product according to a wide range of possibilities based on a combination of a component constituting a support onto which added ingredients are applied, conferring at the same time a taste, visual and, where appropriate, olfactory effect on the combination.

To this end, a food product of the type indicated above is provided which is remarkable in that a binding product is applied to at least part of the surface of the abovementioned product in the form of a film so as to allow binding of the abovementioned added ingredients providing cohesion of the combination, the said binding product being transparent and edible, and the support being at least partially visible.

Other characteristic features of the invention are defined in the subclaims, in particular the selection of the support from rice, bulgur, or precooked wheat.

According to an advantageous embodiment of the invention, the support may be selected from semi-finished products obtained from the abovementioned products, more particularly biscuits, waffles, galettes, gingerbread, cereal bars coated or not coated with sugar and/or chocolate, or alternatively sugar-based, chocolate-based or soft caramel-based sweets, or dragées.

The support is provided with added ingredients in the form of pieces such as dried fruit, candied fruit, chocolate, caramel, vegetables, spices, it being understood that powders may accompany the abovementioned pieces.

Of course, there are whole dry sausages, which are wrapped in a membrane having at their surface added ingredients such as fine herbs or pepper. These added ingredients completely cover the surface, the dry sausages no longer being visible. In this case, the added ingredients are always located on the outside of the membrane on top of it.

On the other hand, according to the present invention, the ingredients are either located directly at the surface of the meat material, with no interface between the added ingredients and the meat material as such. This specific case involves dry sausage slices or membrane-free dry sausages. Alternatively, the ingredients are located outside the membrane on top of it, but the surface of the dry sausages being partially visible. The added ingredients are then dispersed and scattered on the membrane and are therefore individually visible.

The same applies to whole cheeses which can have added ingredients at their surface. They are however only so-called soft cheeses in which it is precisely the soft nature which allows the binding of the added ingredients. Now, by virtue of the present invention, it is also possible to obtain slices or pieces of so-called hard cheese having added ingredients at the surface. Thus, in the present invention, the binding product makes it possible to attach added ingredients on hard cheeses also.

The present invention also relates to a process for the manufacture of a food product as defined in the last appended subclaims.

Thus, according to an advantageous embodiment of the process according to the invention, the added ingredients are bound to the base support, where appropriate pasta and/or other food products having substantially a stick, slice or cube shape, having an essentially meat composition, such as whole dry sausages, by a coating machine. The latter advantageously comprises cylindrical coating means for the production of the food product according to the invention.

In parallel, according to a similar embodiment of the abovementioned process, the added ingredients are attached to the base support, where appropriate pasta, and/or other food products having substantially a stick, slice or cube shape based on cheeses and the like.

According to the present invention, the binding agent has a neutral taste and the process of application does not require a notable increase in temperature. This makes it possible to preserve the organoleptic qualities of the added ingredients, while accentuating them.

Other advantages of the invention are summarized below.

The binding agent is transparent, allowing perfect visualization of the added ingredients and of the support.

The binding agent is non-sticky and non-fatty, which gives an optimized feel to the combination. Consumption of the food products according to the invention is thereby made more convenient and pleasant.

The binding agent is unsweetened, chocolate-free and non-fatty, which increases the dietetic quality of the combination.

The cohesion of the combination is not uncertain and is long-lasting. This makes it possible to improve the stability of the food product even after transportation or placing on shelves for sale.

The binding product is substantially an antioxidant, such that the binding product does not constitute in any manner a product harmful to health. Furthermore, the abovementioned binding product can advantageously protect only the support, or only the added ingredients, or alternatively both.

Thus, the food product according to the invention comprises a support whose base consists of a starchy material selected from the following constituents: rice, precooked wheat, bulgur. However, the abovementioned support may also consist of a semi-finished product obtained from the abovementioned products, more particularly a biscuit, a waffle, a galette or gingerbread in particular.

According to another embodiment of the food product according to the invention, the support may consist of cooked cheese; slices of dry sausage, pudding or saveloy. In addition, the food product according to the invention also comprises edible added ingredients in the form of pieces, which are selected from constituents of the sweet type such as fruit, candied fruit, chocolate or caramel in particular. However, the abovementioned added ingredients may also be of the savoury type, such as vegetables, spices, granular salt, grains, cooked pressed hard or semi-hard cheese. According to a surprising embodiment, the said added ingredients may be selected in the form of pasta, jam, compotes, chocolate, honey and soft cheese, in particular.

According to a preferred embodiment of the invention, the combination is produced by binding added products to the abovementioned support by means of a non-sticky and non-fatty transparent binding food product. In the case where the binding product covers the added ingredients, it acts as an antioxidant film. Furthermore, this means gives the advantage of preserving the visual attraction and the organoleptic qualities of the added ingredients.

Thus, in the present invention, it is not fats which provide the cohesion of the added ingredients but the specific binding product. Furthermore, in the present invention, the binding is obtained without cooking.

Other details will appear from the description given below of a few preferential embodiments of the food product according to the invention given by way of example and illustrated with the aid of the accompanying drawings.

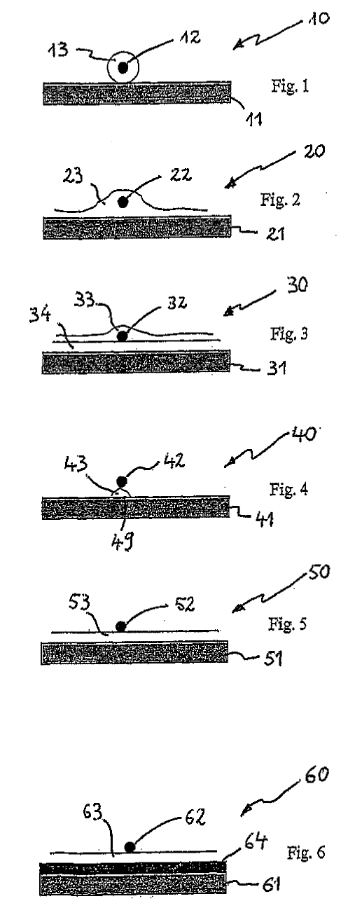

FIG. 1 is a schematic representation of a cross-sectional view of an embodiment of a food product according to the invention in which added ingredients are coated with the binding product, the whole being located on a food support.

FIG. 2 is a schematic representation similar to FIG. 1, in which the binding product covers the combination of the support and the added ingredients.

FIG. 3 is a similar schematic representation of another variant of a food product according to the invention of the multilayer type.

FIG. 4 is a similar schematic representation of a food product according to the invention in which the binding product is only located between the support and the added ingredients.

FIG. 5 is a similar schematic representation of an additional variant of the food product according to the invention in which the binding product covers the entire support, the added ingredients being located on top.

FIG. 6 is a similar schematic representation of yet another variant of the food product according to the invention in which the base layer is itself covered with a food ingredient in the form of a binding and non-transparent layer, this combination receiving the added ingredients according to one of FIGS. 1 to 5.

In general, the present invention relates to a food product comprising a support and edible added ingredients which are individually apparent. FIG. 1 schematically represents a first example of a food product of this type consisting of a film-type binding product 13 which coats the added ingredients 12, the latter being located on the support 11.

Various combinations of food products can be distinguished which consist of the support, on the one hand, and added ingredients in the form of pieces, on the other hand, both constituent parts being integrated by the binding food product 13, forming together the said desired food product. Thus, the whole forms a unit after production.

Advantageously, the binding product 13 is substantially an antioxidant. The latter may in particular completely cover the support 51, 61 only, or only the added ingredients 12, or alternatively the combination of the two 21, 22; 31, 32.

The support is characterized by a larger volume than the added ingredients and at least a relative strength. It is provided in the form of a cube or a slice of meat material such as dried sausage, pudding or saveloy.

As a variant, the support may also consist of a so-called hard cheese material.

According to yet another variant, the support consists of a cereal base of the biscuit, French toast, waffle, galette, gingerbread, Flemish cake, rice galette, rice, precooked wheat or bulgur type, for example.

The added ingredients 12 are characterized by a smaller volume, typically substantially smaller than the support 11, such as pieces for example, and at least a relative strength. They have a sweet taste in the form of fruit—fresh, dried and/or candied—or caramel for example. The added ingredients may however also consist of small cheese pieces, of an unsweetened nature, such as fine herbs, spices, grains and seeds, or granular salt.

The binding product is in a liquid, viscous or powdery state during its use.

The substantially antioxidant nature of the binding product may be enhanced by the addition of antioxidant agents.

The base binding product is substantially non-fatty, chocolate-free and unsweetened. Its basic neutral taste may however be modified by the addition of flavourings, salt or sugar depending on the final product to be made. After carrying out the process, its state is non-sticky to the touch and substantially solid.

The binding product consists mainly of a concentrate of proteins and/or starch and/or gelatin.

In FIG. 2, the binding product 23 covers the entire support 21 and added ingredients 22.

The case of a layer of binding product 33 between the support 31 and the added ingredients 32 with a second layer of binding product 43 covering the added ingredients 32 is shown in FIG. 3.

In the variant shown in FIG. 4, the binding product 43 is solely located between the support 41 and the added ingredients 42.

The binding product 53 may advantageously cover the entire support 51, the added ingredients 52 being located on top, as shown in FIG. 5.

The base layer 61 may itself be advantageously covered with a food ingredient in the form of a binding and non-transparent film layer 63, as shown in FIG. 6, this combination receiving the added ingredients 62 according to one of FIGS. 1 to 5.

The process for the manufacture of the food product described above is advantageously performed without cooking. With the process for the manufacture of the food product illustrated in FIG. 1, the added ingredients 12, of which only one is schematically represented in FIG. 1, are coated with binding product 13 and are then located on the support 11. It should be understood, however, that the added ingredients are distributed on the abovementioned support in a number which is large to a greater or lesser degree.

In this regard, the temperature of the base layer, of the added ingredients, of the binding food product and of the combination does not exceed at any moment 50° C.

As for the support, its temperature does not exceed at any moment 30° C. The temperature of the binding food product and of the combination does not exceed, for its part, at any moment 40° C.

Preferably, the abovementioned temperature ranges do not exceed at any moment 30° C., 10° C. and respectively 20° C.

The process comprises the steps consisting of
first introducing the support 11, . . . , 61 into the cylinder,
then setting the cylinder in rotation, preferably between 1 and 10 revolutions/minute,
introducing added ingredients 12, . . . , 62 and then the binding food product 13, . . . , 63 and finally
drying the combination, preferably with dry air, preferably still to 16% moisture or less.

Alternatively, the steps for introducing the added ingredients and respectively the binding product may be reversed.

The abovementioned product may be introduced into a packaging means and the combination applied to the said packaging means by the abovementioned binding product.

According to a variant of the process, the added ingredients 22 are deposited on the support 21, this combination then being covered with binding product 23.

According to another variant of the process, the support 31 receives a layer of binding product 34 on which are deposited the added ingredients 32, themselves covered with binding product 33.

In yet another variant of the process, the binding product 43 is deposited solely at preselected locations 49 of the added ingredients 42.

FIG. 5 illustrates an additional variant of the process in which the binding product 53 is applied so as to cover the whole of the support 51 on which the added ingredients 52 are deposited.

1. A food support comprising a support (11, . . . , 16) composed of an edible substance, on the one hand, and edible added ingredients (21, . . . , 26) which are individually apparent, on the other hand, characterized in that a binding product (31, . . . , 36) is applied to at least part of the surface of the abovementioned product in the form of a film so as to allow binding of the abovementioned added ingredients (21, . . . , 26) providing cohesion of the combination (10, . . . , 60) and in that said binding product (31, . . . , 36) is transparent and edible, and the support being at least partially visible.

2. A food product according to claim 1, characterized in that the binding product (31, . . . , 36) is not sticky adhesive and non-fatty.

3. A food product according to the preceding claim, characterized in that the binding product (31, . . . , 36) is substantially solid.

4. A food product according to one of the preceding claims, characterized in that the binding product (31, . . . , 36) is unsweetened.

5. A food product according to one of the preceding claims, characterized in that the binding product (31, . . . , 36) is chocolate-free.

6. A food product according to one of the preceding claims, characterized in that the binding product (31, . . . , 36) is substantially antioxidant.

7. A food product according to one of the preceding claims, characterized in that the binding product (31, . . . , 36) contains agents such as antioxidants and/or enzymes and/or nutritional agents such as vitamins and/or trace elements.

8. A food product according to one of the preceding claims, characterized in that the binding product (31, . . . , 36) contains salt flavouring additives.

9. A food product according to one of the preceding claim, characterized in that the binding product (31, . . . , 36) contains sugar flavouring additives.

10. A food product according to one of the preceding claims, characterized in that the binding product (31, . . . , 36) consists mainly of proteins.

11. A food product according to one of the preceding claims, characterized in that the added ingredients (21, . . . , 26) are applied in relief relative to the support (10, . . . , 16), so as to be external to the said support (11, . . . , 16).

12. A food product according to one of the preceding claims, characterized in that the added ingredients (21, . . . , 26) consist of pieces such as dried fruit, candied fruit, chocolate, caramel, vegetables, spices, grains.

13. A food product according to one of the preceding claims, characterized in that the added ingredients (21, . . . , 26) have a size greater than 4 millimetres.

14. A food product according to one of the preceding claims, characterized in that the support (11, . . . , 16) consists of starch material.

15. A food product according to the preceding claim, characterized in that the support (11, . . . , 16) consists of rice, precooked wheat, bulgur or biscuits, waffles, galettes, cakes in particular made from the abovementioned products or gingerbread.

16. A food product according to one of the claims 1 to 13, characterized in that the support (11, . . . , 6) consists mainly of meat materials such as slices, pieces or sticks of dry sausage, pudding and/or saveloy.

17. A food product according to one of the claims 1 to 13, characterized in that the support (11, . . . , 16) consists of fragments of so-called hard cheese, such as slices, pieces or sticks.

18. A food product according to one of the claims 1 to 13, characterized in that the support (10) consists of a soybean base.

19. A manufacturing method of a food product according to anyone of the preceding claims, characterized in that the manufacturing process is carried out without cooking.

20. Method according to the preceding claim, characterized in that at least part of the added ingredients (12) are coated with binding product (13), which added ingredients (12) are then located on the support (11).

21. Method according to one of the claims 19 or 20, characterized in that added ingredients (22) are deposited on the support (21), the abovementioned combination (21, 22) then being covered with binding product (23).

22. Method according to one of the claims 19 or 20, characterized in that the support (31) receives a layer of binding product (34) on which are deposited added ingredients (32), themselves covered with binding product (33).

23. Method according to one of the claims 19 or 20, characterized in that the binding product (43) is deposited solely at preselected locations (49) of added ingredients (42).

24. Method according to one of the claims 19 or 20, characterized in that the binding product (53) is applied so as to cover the entire support (51) on which added ingredients (52) are deposited.

25. Method according to one of the claims 19 to 24, characterized in that the added ingredients are bound to the base support, where appropriate pasta, and/or other food products having substantially the shape of a stick, slice, cube or pellets, with an essentially meat composition, such as whole dry sausages or slices of dry sausages, by a coating machine.

26. Method according to one of the claims 19 to 24, characterized in that the added ingredients are bound to the base support, where appropriate pasta and/or other food products having substantially the shape of a stick, slice, cube or pellets, based on cheese, by a coating machine.

27. Method according to one of the preceding claims 19 to 26, when it depends of claim 14 or 15, characterized in that the temperature of the base layer (11, . . . , 61), the added ingredients (12, . . . , 62), the binding food product (13, . . . , 63) and the combination (10, . . . , 60) does not exceed at any moment 50° C., or even preferably 30° C.

28. Method according to one of the preceding claims 19 to 27, when it depends of one of the claims 16 to 18, characterized in that the temperature of the support (11, . . . , 61) does not exceed at any moment 30° C., or even 10° C.

29. Method according to one of the preceding claims when it depends of one of the claims 16 to 18, characterized in that the temperature of the binding food product (13, . . . , 63) and of the combination (10, . . . , 60) does not exceed at any moment 40° C., or even preferably 20° C.

30. Method according to one of the preceding claims 27 to 29, characterized in that it comprises the steps consisting of
first introducing the support (11, . . . , 61) into a cylinder,
then setting the cylinder in rotation, preferably between 1 and 10 revolutions/minute,
introducing added ingredients (12, . . . , 62) and then the binding food product (13, . . . , 63) and finally
drying the combination, preferably with dry air, preferably still to 16% moisture or less.

31. Method according to the preceding claim in which the steps of introducing the added ingredients (12, . . . , 62) and respectively the binding product (30) are reversed.

32. Method according to claim 28 or 29, characterized in that the procedure for the process is followed by coating of the product aimed at improving the presentation or preservation of the combination.

33. Method according to anyone of the claims, characterized in that the abovementioned product is introduced into a packaging means and the combination is applied to the said packaging means by the abovementioned binding product.
